(19) United States
(12) Patent Application Publication
(10) Pub. No.: US 2012/0288793 A1
(43) Pub. Date: Nov. 15, 2012

(54) METHOD FOR PRODUCING TONER

(75) Inventors: Dong Won Kim, Incheon-city (KR); Sung Yul Kim, Cheongju-si (KR); Bo Young Kim, Seoul (KR); Il Sun Hwang, Daejeon-city (KR); Sung Soon Kim, Gwangmyeong-si (KR)

(73) Assignee: SAMSUNG FINE CHEMICALS CO., LTD., Ulsan (KR)

(21) Appl. No.: 13/574,698

(22) PCT Filed: Feb. 1, 2011
(86) PCT No.: PCT/KR2011/000739

§ 371 Date: Jul. 23, 2012

(30) Foreign Application Priority Data
Feb. 5, 2010 (KR) 10-2010-0011181

(51) Int. Cl. G03G 9/08

(52) U.S. Cl. 430/137.14

(57) ABSTRACT

Disclosed is a method for producing toner. The method for producing toner by emulsion aggregation according to the present invention, comprises adjusting viscosity at a homogenization stage, to thereby obtain toner particles having a dense particle size distribution via a simple process.

### TECHNICAL FIELD

The present invention relates to a method for producing toner by emulsion aggregation, and more particularly, to a method for producing toner having a dense particle size distribution.

### BACKGROUND ART

In general, toner is prepared by mixing a thermoplastic resin, as a binder resin, with a colorant, a wax, or the like. In addition, inorganic fine metal particles such as silica or a titanium oxide may be added to toner as external additives in order to provide the toner with fluidity or improve physical properties of toner such as charge controlling properties or cleaning properties. Toner is prepared using a physical method such as pulverization or a chemical method such as suspension polymerization and emulsion aggregation.

In general, according to a method of producing toner by emulsion aggregation, toner particles are aggregated using a binder resin in a latex phase, a colorant, and a wax by using a coagulant, and coalesced. More particularly, the method includes mixing a latex dispersion, a colorant dispersion, and a wax dispersion, homogenizing the mixture by adding a coagulant thereto, forming toner particles by aggregating the homogenized mixture, coalescing the aggregated toner particles, and washing and drying the coalesced toner particles. If viscosity of the mixture is too high during the homogenizing process, reactants may adhere to an inner wall of a reactor as the reaction scale increases. Thus, due to the reactants which are adhered to the inner wall and are not stirred, large toner particles are formed as temperature increases after the coalescing process, so that the toner particles have a wide particle size distribution.

### DETAILED DESCRIPTION OF THE INVENTION

### Technical Problem

The present invention provides a method for producing toner by emulsion aggregation by which toner having a dense particle size distribution may be prepared.

### Technical Solution

According to an aspect of the present invention, there is provided a method for producing toner, the method including:

mixing a latex resin dispersion, a colorant dispersion, and a wax dispersion;

homogenizing the mixture by adding a coagulant to the mixture;

forming toner particles by aggregating the homogenized mixture; and

coalescing the aggregated toner particles, wherein the homogenizing is performed at a temperature in the range of a glass transition temperature (Tg) of the latex resin—15° C. to a Tg—10° C.

A viscosity of the mixture during the homogenization measured using a Brookfield viscometer may be in the range of 50 to 100 cPs at 25° C. at 200 rpm.

The latex resin dispersion may include a polyester resin not including a sulfonic acid group or a phosphoric acid group.

### Advantageous Effects

According to a method for producing toner according to one or more embodiments of the present invention, toner having a dense particle size distribution may be simply prepared.

### MODE OF THE INVENTION

Hereinafter, the present invention will be described more fully, in which exemplary embodiments of the invention are shown.

A method for producing toner according to an embodiment of the present invention includes: mixing a latex resin dispersion, a colorant dispersion, and a wax dispersion; homogenizing the mixture by adding a coagulant to the mixture; forming toner particles by aggregating the homogenized mixture; and coalescing the aggregated toner particles, wherein the homogenizing is performed at a temperature in the range of a glass transition temperature (Tg) of the latex resin—15° C. to a Tg—10° C.

According to a conventional method of preparing toner by emulsion aggregation, a reaction mixture is homogenized by adding a coagulant to the reaction mixture at room temperature, toner particles are aggregated during a primary heating process, and the toner particles are coalesced during a secondary heating process. However, according to the current embodiment, the particle size distribution of toner particles may be narrowed since the reaction mixture is easily homogenized by adding a coagulant to the reaction mixture at a temperature ranging from a Tg of the latex—15° C. to a Tg—10° C., and processing time and manufacturing costs may be reduced since the aggregation is performed at the same temperature of the homogenization, and there is no need to control the primary heating rate for aggregate toner particles.

A viscosity of the reaction mixture during the homogenization measured using a Brookfield viscometer is in the range of 50 to 100 cPs at 25° C. at 200 rpm.

The growth of toner particles is stopped when the toner particle has a desired particle size by adjusting the pH, and the aggregated toner particles are coalesced, washed, and dried to obtain desired toner particles. The dried toner particles are treated with external additives using, for example, silica, and a charge quantity thereof is adjusted to obtain desired toner for laser printers.

The method for producing toner according to the current embodiment may be applied to toner having a core-shell structure, and the toner having a core-shell structure may be prepared by preparing primarily aggregated toner by adding a coagulant into a mixture of a latex dispersion for a core, a colorant dispersion, and a wax dispersion, and homogenizing and aggregating the mixture; forming a shell by adding a latex for a shell to the primarily aggregated toner; and coalescing the structure.

The latex resin used in the method of preparing the toner according to the current embodiment may be prepared by polymerizing at least one polymerizable monomer selected from the group consisting of a vinyl-based monomer, a polar monomer having a carboxyl group, a monomer having an unsaturated ester group, and a monomer having a fatty acid group.

The latex resin may include a polyester resin not including a sulfonic acid group or a phosphoric acid group.

The polyester resin may be prepared by polycondensation of an acid component and an alcohol component. Polybasic carboxylic acid is used as the acid component, and polyhydric alcohol is used as the alcohol component.

Examples of the polyhydric alcohol component include polyoxyethylene-(2,0)-2,2-bis(4-hydroxyphenyl)propane, polyoxypropylene-(2,0)-2,2-bis(4-hydroxyphenyl)propane, polyoxypropylene-(2,2)-polyoxyethylene-(2,0)-2,2-bis(4-hydroxyphenyl)propane, polyoxyethylene-(2,3)-2,2-bis(4-hydroxyphenyl)propane, polyoxypropylene-(6)-2,2-bis(4-hydroxyphenyl)propane, polyoxypropylene-(2,3)-2,2-bis(4-hydroxyphenyl)propane, polyoxypropylene-(2,4)-2,2-bis(4-hydroxyphenyl)propane, polyoxypropylene-(3,3)-2,2-bis(4-hydroxyphenyl)propane, polyoxyethylene-(6)-2,2-bis(4-hydroxyphenyl)propane, ethylene glycol, 1,3-propylene glycol, 1,2-propylene glycol, 1,4-butylene glycol, 1,3-butylene glycol, glycerol, and polyoxypropylene. Examples of the polybasic carboxylic acid component include an aromatic polybasic acid and/or an alkyl ester thereof that are commonly used in the preparation of polyester resin. Examples of the aromatic polybasic acid include terephthalic acid, isophthalic acid, trimellitic acid, pyromellitic acid, 1,2,4-cyclohexane tricarboxylic acid, 2,5,7-naphthalene tricarboxylic acid, 1,2,4-naphthalene tricarboxylic acid, 1,2,5-hexane tricarboxylic acid, 1,2,7,8-octane tetracarboxylic acid, and/or alkyl esters of these carboxylic acids, wherein the alkyl group may be a methyl group, an ethyl group, a propyl group, or a butyl group. The aromatic polybasic acid and/or alkyl esters thereof may be used alone or in a combination of at least two thereof.

The polyester resin has a weight average molecular weight ranging from 6,000 to 100,000, a polydispersity index (PDI, Mw/Mn) ranging from 2 to 15, and an acid value ranging from about 2 to about 20. In addition, the polyester resin may have a Tg in the range of 50 to 80° C.

The colorant may be used in the form of a pigment itself, or alternatively, in the form of a pigment master batch in which the pigment is dispersed in a resin.

The pigment may be selected from pigments that are commonly and commercially used, such as a black pigment, a cyan pigment, a magenta pigment, a yellow pigment, and a mixture thereof.

The amount of the colorant may be sufficient to color the toner and form a visible image by development, for example, in the range of 1 to 20 parts by weight based on 100 parts by weight of the binder resin.

Meanwhile, a charge control agent may be used as an additive.

The charge control agent may be a negative charge control agent and a positive charge control agent. Since the charge control agent stably and quickly charges toner by its electrostatic force, the toner may be stably supported on a developing roller.

The amount of the charge control agent contained in toner may be in a range of about 0.1 parts by weight to about 10 parts by weight based on 100 parts by weight of the total toner composition.

Wax improves fixing properties of a toner image. Examples of the wax include polyalkylene wax, such as low molecular weight polypropylene and low molecular weight polyethylene, ester wax, carnauba wax, and paraffin wax. The amount of the wax contained in toner may be in a range of about 0.1 parts by weight to about 30 parts by weight based on 100 parts by weight of the total toner composition. If the amount of the wax is less than 0.1 parts by weight, oilless fixing of toner particles in which toner particles are fixed without using oil cannot be performed. On the other hand, if the amount of the wax is greater than 30 parts by weight, toner may be flocculated while it is stored.

The additives may further include external additives. The external additives are used to improve fluidity of the toner or control charge properties of the toner. Examples of the external additives include large particulate silica, small particulate silica, and polymer beads.

Hereinafter, one or more embodiments will be described in detail with reference to the following examples. However, these examples are not intended to limit the purpose and scope of the invention.

### Example 1

(1) Preparation of Polyester Resin Dispersion

1) Synthesis of polyester resin

50 g of dimethyl terephthalate, 47 g of dimethyl isophthalate, 80 g of 1,2-propylene glycol, and 3 g of trimellitic acid were added to a 5 L reactor equipped with a stirrer, a thermometer, a nitrogen gas inlet, and a cooler. 500 ppm of dibutyltin oxide, based on the weight of the mixture of the monomers, was added as a catalyst, and the reactants were heated to 150° C. and maintained at 150° C. for 8 hours while stirring at 200 rpm. Then, the reactor was heated to 200° C., and unreacted reactants and by-products were removed by reducing pressure. A Tg of the prepared polyester resin was 63° C. (Jade DSC+AS, Perkin Elmer), and an acid value measured by titration of the polyester resin was 12 mgKOH/g. A weight average molecular weight of the polyester resin measured by gel permeation chromatography including an RI detector (Waters 2690) was 25,000, and a PDI thereof was 3.2.

The Tg, acid value, and weight average molecular weight of the polyester resin were measured as follows.

Measurement of Glass Transition Temperature (Tg, ° C.)

The glass transition temperature (Tg) of a sample was measured using a differential scanning calorimeter (DSC, manufactured by Netzsch Co.) by heating the sample from 20 to 200° C. at 10° C./min, rapidly cooling the sample to 10° C. at 20° C./min, and heating the sample at 10° C./min.

Acid Value

The acid value (mgKOH/g) was measured by dissolving the resin in a dichloromethane, cooling the solution, and titrating the solution with a 0.1N KOH methyl alcohol solution.

Weight Average Molecular Weight

The weight average molecular weight of a binder resin was measured by gel permeation chromatography (GPC) using a calibration curve obtained using a polystyrene standard sample.

2) Manufacture of Aqueous Phase

200 g of deionized water, 2.22 g of alkyldiphenyloxide disulfonate (45% Dowfax 2A1), 300 mL of 0.1N NaOH were added to a 3 L thermostatic reactor equipped with a stirrer, and the reactor was stirred at 350 rpm until the temperature reached 80° C.

3) Manufacture of Organic Phase

100 g of 2-butanone and 100 g of the polyester resin synthesized in operation 1) above were added to a 1 L thermostatic reactor equipped with a stirrer, and the reactor was maintained at 75° C. while stirring at 150 rpm.

4) Preparation of Polyester Resin Dispersion

When the polyester resin is dissolved in the organic phase in operation 3) above and becomes transparent, the organic phase was added to the aqueous phase prepared in operation 2) above while stirring at 200 rpm. After the organic phase was added, the mixture was further stirred for 1 hour.

A particle size was measured in a solution by using a Microtrac. An average particle diameter of the polyester resin dispersion (D50) was equal to or less than 200 nm, and the particle size distribution exhibited a monodispersion with 0.35 or less.

(2) Preparation of Pigment Dispersion

540 g of a cyan pigment, (Daicolor Pigment MFG. Co. Ltd., Japan, ECB303), 27 g of alkyldiphenyloxide disulfonate (45% Dowfax 2A1), as an anionic surfactant, and 2,450 g of distilled water were added to a 4 L reactor equipped with a stirrer, and the mixture was pre-dispersed for about 5 hours and dispersed at 1500 bar using a Ultimizer (Armstec Ind. Co., Ltd.) until the particle size was 200 nm or less. As a result, a pigment dispersion having a particle size of 170 nm (measured by using a Microtrac) was prepared.

(3) Preparation of Wax Dispersion

As in the preparation of the pigment dispersion, 65 g of alkyldiphenyloxide disulfonate (45% Dowfax 2A1), as an anionic surfactant, 1.935 kg of distilled water, and 580 g of a wax (Chukyo Yoshi Co., Ltd., Japan, P-778) were added to a 5 L reactor, and the reactor was heated to a high temperature (80° C. or higher) and stirred for 2 hours. When the wax was dissolved, the mixture was dispersed by using a HOMO (Niro-Soavi) at 600 bar for 2 hours. The dispersion was performed at a melting point of the wax+15° C. After the dispersion, the particle size of the wax dispersion was 220 nm (measured using a Microtrac).

(4) Aggregation/Freezing/Coalescence Process

The polyester resin dispersion, the pigment dispersion, and the wax dispersion prepared as described above were mixed. The mixture was heated to 53° C., and 10 g of an inorganic acid (0.3 M, nitric acid solution) and NaCl, as a coagulant (4.5 wt % based on the mass of the solid contents of the reaction mixture), were added to the mixture. Then, the mixture was homogenized by using an IKA Homogenizer at 10000 rpm for 5 minutes and toner particles were aggregated. In this regard, the mass ratio of the solid contents of the polyester resin dispersion, the pigment dispersion, and the wax dispersion was 85:7:8, and the total solid contents of the reaction mixture was 13 wt %. The pH of the reaction mixture was adjusted to about 5.6 by using a 0.3 M nitric acid solution.

An average particle diameter (d50) of the toner was 6.3±0.5 μm, and GSDv and GSDp values were 1.3 or less. The average particle diameter and the particle size distribution were measured by using a Coulter Counter (Beckman Coulter).

Coalescence was performed by adding a 1N NaOH solution by 70% of the equivalent of the coagulant and stirring the mixture while the temperature for the aggregation was maintained, and then increasing the temperature to 95° C. or higher until circularity reached 0.985 or greater.

(5) Washing and Drying Process

The toner particles were washed several times with ultrapure water until an electrical conductivity of the washed water reached 50 μS/cm or less, the pH of the resultant was adjusted to 1.5 by using 0.3 M nitric acid, and then the resultant was washed using ultrapure water such that an electrical conductivity of the washed solution was 10 μS/cm or less. The washed wet cake of toner was dried such that a water content was 1% or less.

### Example 2

Toner particles were prepared in the same manner as in Example 1, except that the homogenizing was performed for 10 minutes.

### Example 3

Toner particles were prepared in the same manner as in Example 1, except that the temperature for the homogenizing was maintained at 48° C.

### Comparative Example 1

Toner particles were prepared in the same manner as in Example 1, except that the temperature for the homogenizing was maintained at room temperature.

### Comparative Example 2

Toner particles were prepared in the same manner as in Example 1, except that the temperature for the homogenizing was maintained at 35° C.

Evaluation

Hereinafter, physical properties of the toner particles prepared in Examples 1 to 3 and Comparative Examples 1 and 2 were measured as follows.

GSDp and GSDv of the toner particles prepared in Examples 1 to 3 and Comparative Examples 1 and 2 were calculated by Equations 1 and 2 below using average particle diameters measured using a Multisizer™ 3 Coulter Counter® (manufactured by Beckman Coulter Inc.). Aperture of 100 μm was used in the Multisizer™ 3 Coulter Counter, and an appropriate amount of a surfactant was added to 50 to 100 ml of ISOTON-II (Beckman Coulter Co.), as an electrolyte, and 10 to 15 mg of a sample to be measured was added thereto, and the resultant was dispersed in an ultrasonic dispersing apparatus for 5 minute to prepare a sample.

$$\begin{matrix}GSDp = \sqrt{\frac{D 84 p}{D 16 p}} \\ ( p : number of particles ) & Equation 1 \\ GSDv = \sqrt{\frac{D 84 v}{D 16 v}} \\ ( v : volume ) & Equation 2\end{matrix}$$

Particle size distribution was evaluated as follows.
⊚: d50(v) 6.0˜7.0 μm, GSDp<1.30, GSDv<1.25,
   % of <3 μm(n)<3.0%
∘: d50(v) 6.0˜7.0 μm, GSDp<1.40, GSDv<1.35,
   % of <3 μm(n)<5.0%
Δ: d50(v) 6.0˜7.0 μm, GSDp>1.40, GSDv>1.35,
   % of <3 μm(n)>5.0%
x: d50(v)>7.0 μm, GSDp>1.40, GSDv>1.35,
   % of <3 μm(n)>5.0%

Fluidity of a toner sample was measured by using a Micron Powder Characteristics Tester (HOSOKAWA) under N/N condition and H/H condition. As a value obtained therefrom decreases, fluidity increases.

N/N Condition: 2 hr, 25° C., humidity 55%

H/H Condition: 15 hr, 50° C., humidity 80%+2 hr, 25° C., humidity 55%

Charge amounts were measured using a q/m meter (EPPING PES-Laboratorium).

Evaluation of charge amount (on opc)
⊚: −50 to −40 (q/m)
◯: −40 to −30 (q/m)
Δ: −30 to −20 (q/m)
x: −20 to −10 (q/m)

Viscosity of a homogenized sample was measured by using a Brookfield viscometer for 1 minute with 63 spindles at 200 rpm.
⊚: 50 to 75
∘: 76 to 100
Δ: 101 to 150
x: 150 to 200

The results of the evaluation are shown in Table 1 below.

TABLE 1

| | Final | | Vis- | | | |
|---|---|---|---|---|---|---|
| | Particle size | Yield | cosity | Fluidity | Fluidity | Charge |
| | distribution | (%) | (cps) | (H/H) | (N/N) | amount |
| Example 1 | ⊚ | 83 | ⊚ | 75.4 | 73.0 | ⊚ |
| Example 2 | ◯ | 81 | ◯ | 80.3 | 76.2 | ◯ |
| Example 3 | ⊚ | 80 | ⊚ | 77.2 | 74.5 | ⊚ |
| Comparative | X | 75 | X | 89.1 | 80.5 | Δ |
| Example 1 | | | | | | |
| Comparative | Δ | 71 | Δ | 90.2 | 82.5 | Δ |
| Example 2 | | | | | | |

As shown in Table 1, toner prepared using the method according to the present invention has a dense particle size distribution, high fluidity, and excellent charge properties. In addition, since the viscosity is low, toner particles adhered to the wall of the reactor is reduced, thereby increasing the yield.

It should be understood that the exemplary embodiments described therein should be considered in a descriptive sense only and not for purposes of limitation. Descriptions of features or aspects within each embodiment should typically be considered as available for other similar features or aspects in other embodiments.

1. A method for producing toner, the method comprising:
mixing a latex resin dispersion, a colorant dispersion, and a wax dispersion;
homogenizing the mixture by adding a coagulant to the mixture;
forming toner particles by aggregating the homogenized mixture; and
coalescing the aggregated toner particles,
wherein the homogenizing is performed at a temperature in the range of a glass transition temperature (Tg) of the latex resin—15° C. to a Tg—10° C.

2. The method of claim 1, wherein a viscosity of the mixture during the homogenization measured using a Brookfield viscometer is in the range of 50 to 100 cPs at 25° C. at 200 rpm.

3. The method of claim 1, wherein the latex resin dispersion comprises a polyester resin not including a sulfonic acid group or a phosphoric acid group.

4. The method of claim 3, wherein the polyester resin has a weight average molecular weight of 6,000 to 100,000 and a glass transition temperature (Tg) of 50 to 80° C.

5. The method of claim 1, further comprising washing and drying the toner particles after the coalescing process.
